(19) United States
(12) Patent Application Publication
(10) Pub. No.: US 2014/0023819 A1
(43) Pub. Date: Jan. 23, 2014

(54) Foam with Oriented Laminated Mesh Backing

(71) Applicant: David M. Pritchard, Suwanee, GA (US)

(72) Inventor: David M. Pritchard, Suwanee, GA (US)

(73) Assignee: PAK-LITE, INC., Suwanee, GA (US)

(21) Appl. No.: 13/555,131

(22) Filed: Jul. 21, 2012

(51) Int. Cl. B32B 3/06; B32B 38/00; B32B 37/04

(52) U.S. Cl. 428/101; 442/1; 156/308.2; 156/250

(57) ABSTRACT

A reinforced material includes a foam layer that has a first side. A pre-stretched laminated oriented mesh fabric is fused to at least a portion of the first side. In a method of making a reinforced material, a pre-stretched laminated oriented mesh fabric is applied to a first side of a foam layer. The pre-stretched laminated oriented mesh fabric is fused to the first side of the foam layer until the pre-stretched laminated oriented mesh fabric becomes bonded to the first side.

### BACKGROUND OF THE INVENTION

1. Field of the Invention

The present invention relates to foam products and, more specifically, to a foam product with a laminated mesh backing

2. Description of the Related Art

Plastic foam is used in thousands of applications, including packaging, insulation and padding. Such foam can be found in many configurations, including in sheet form. Polyethylene is one common plastic used in foam sheets.

Firmness is an important property of foam sheets. With respect to foam sheets, firmness is the resistance of the foam to an externally applied force and is often measured by the amount of deflection force per unit area necessary to achieve a predetermined compression depth as a percentage of the thickness of a sheet.

The firmness of a foam sheet can be a result of several factors, including the density of the foam, the chemical structure of the plastic used in the foam, the structure of the cells in the foam and the thickness of the foam sheet. Foam sheet manufacturers often make foam sheets of a desired firmness by laminating several layers of foam to each other to achieve a firmness greater than that of the firmness of a single sheet of foam. However, laminating sheets of foam to each other results in increased costs both as a result of the cost of the additional sheets of foam and the cost of the lamination process.

Therefore, there is a need for a method of increasing the firmness of a foam sheet without laminating additional sheets to the foam sheet and without having to use foam of an increased density.

### SUMMARY OF THE INVENTION

The disadvantages of the prior art are overcome by the present invention which, in one aspect, is a reinforced material that includes a foam layer that has a first side. A pre-stretched laminated oriented mesh fabric is fused to at least a portion of the first side.

In another aspect, the invention is a reinforced foam that includes a polyethylene foam layer having a first side. A pre-stretched laminated oriented polyethylene mesh fabric fused to the first side.

In yet another aspect, the invention is a method of making a reinforced material, in which a pre-stretched laminated oriented mesh fabric is applied to a first side of a foam layer. The pre-stretched laminated oriented mesh fabric is fused to the first side of the foam layer until the pre-stretched laminated oriented mesh fabric becomes bonded to the first side.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a top plan view of one embodiment of a foam with an oriented laminated mesh backing

FIG. 1B is a cross-sectional view of the embodiment shown in FIG. 1A, taken along line 1B-1B.

FIG. 2A is an elevational view of an embodiment of a foam with an oriented laminated mesh backing that includes a cut.

FIG. 2B is an elevational view of the embodiment shown in FIG. 2A, in which two portions of the foam are hingedly separated from each other.

FIG. 2C is a cross sectional view of a cooler made according to the embodiment shown in FIGS. 2A and 2B.

FIG. 3 is a schematic diagram showing one apparatus for making a embodiment of a foam with an oriented laminated mesh backing.

FIG. 4 is a photograph of one embodiment of a reinforced material.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” As used herein, “fuse” means to couple a first layer to a second layer so that the first layer becomes bonded to the second layer.

U.S. Pat. No. 6,106,924, issued to Yamazaki, U.S. Pat. No. 5,032,442 issued to Yamazaki et al., and U.S. Pat. No. 6,033,509 issued to Miyamoto et al. disclose pre-stretched laminated oriented mesh fabrics and methods of making pre-stretched laminated oriented mesh fabrics. These patents are hereby incorporated herein by reference for the purpose of disclosing pre-stretched laminated oriented mesh fabrics and methods of making pre-stretched laminated oriented mesh fabrics.

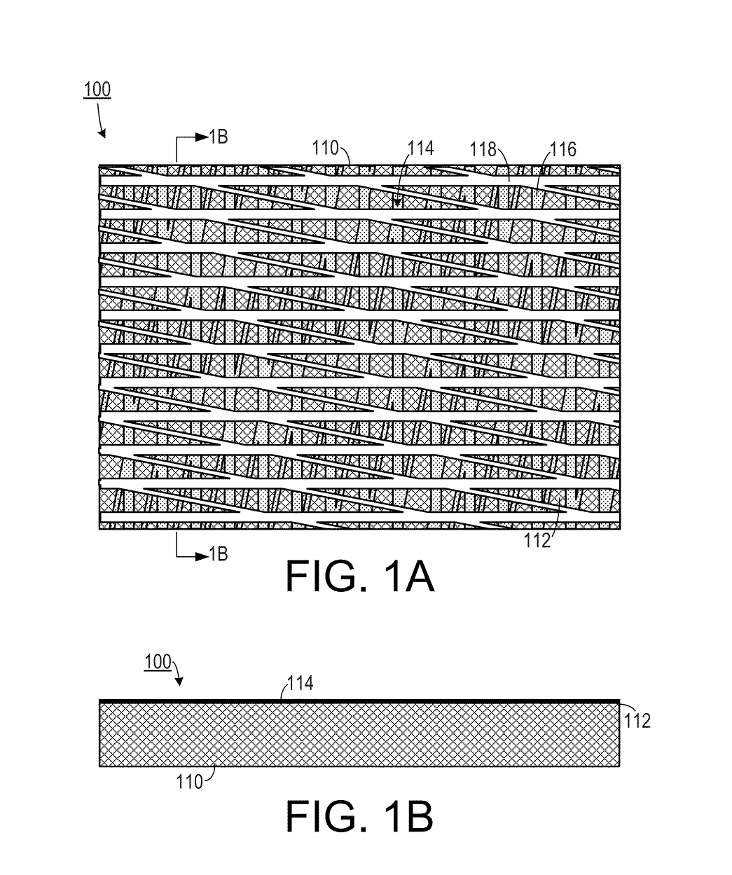

As shown in FIGS. 1A and 1B, one embodiment is a reinforced material 100 that includes a foam layer 110 having a first side 112. The foam layer 110, in one embodiment, includes a thermoplastic resin, which in one representative example includes polyethylene. As will be readily appreciated, many other types of foam can be employed with the invention, including thermoset foams and natural foams.

A pre-stretched laminated oriented mesh fabric 114 is fused to the first side 112 of the foam layer 110. In one representative embodiment, the pre-stretched laminated oriented mesh fabric 114 includes a first layer 116 of pre-stretched plastic sheet that is laminated to a second layer 118 of pre-stretched plastic sheet, wherein the second layer 118 has an orientation that is different from the orientation of the first layer 116. In one embodiment, the pre-stretched laminated oriented mesh fabric 114 comprises a thermoplastic resin, which can include polyethylene.

The mesh fabric 114, being fused to the foam layer 110, distributes force laterally across the first side 112, thereby increasing the amount of area that the force is applied to. As a result, the unit force per unit area decreases with the mesh fabric 114 fused to the foam layer 110 for a give force applied to the reinforced material 100, so that the resulting reinforced material 100 is firmer that the foam layer 110 by itself. This increase in firmness is accomplished without having to use denser foam or having to laminate additional layers of foam to each other.

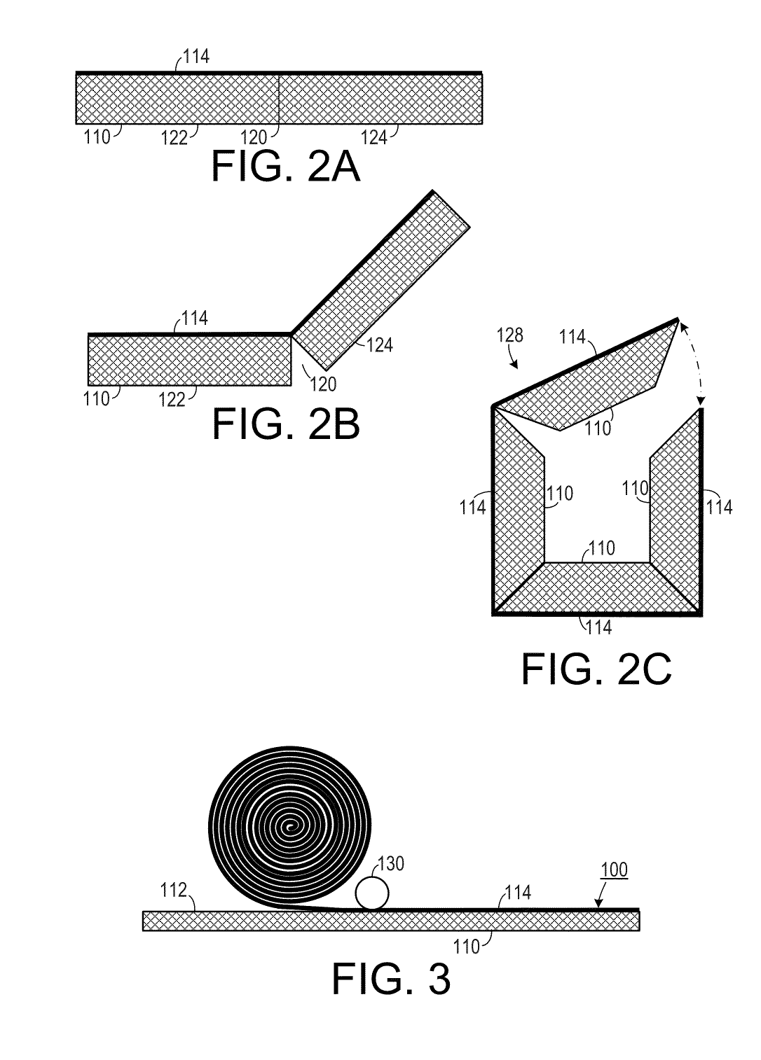

In one embodiment, shown in FIGS. 2A and 2B, the foam layer 110 can define a lengthwise cut 120 that divides the foam layer 110 into a first part 122 and a second part 124. The pre-stretched laminated oriented mesh fabric 114 then acts as a hinge between the first part 122 and the second part 124. The cut 120 can be made with such devices as a saw, a knife, a heated wire, or any other device known in the art for cutting foam in a controlled manner.

This embodiment can be useful when making three-dimensional structures from a foam sheet. For example, as shown in FIG. 2C, one can construct a soft cooler 128 simply by cutting the reinforced material 100 in such a way that the resulting sheet folds readily into a box shape. In the example shown, the cuts are made at 45° angles. As will be readily appreciated by those of skill in the art, many other shapes may be achieved using this method.

As shown in FIG. 3, in one method of making a reinforced material 100 using a thermoplastic foam and a thermoplastic fabric, a pre-stretched laminated oriented mesh fabric 114 is applied to the first side 112 of a foam layer 110. The pre-stretched laminated oriented mesh fabric 114 and the first side 112 of a foam layer 110 are heated under pressure to a temperature for a sufficient amount of time until they fuse together. In one embodiment, a calendar roll 130 may be used to apply heat and pressure to the mesh fabric 114. As will be readily appreciated, the fusing temperature will depend on a number of factors, including the thermoplastic type. The fusing temperature and the amount of time can be readily determined by increasing the temperature applied to a sample of the fabric and the foam until they fuse and then recording the temperature and time that achieved the desired result.

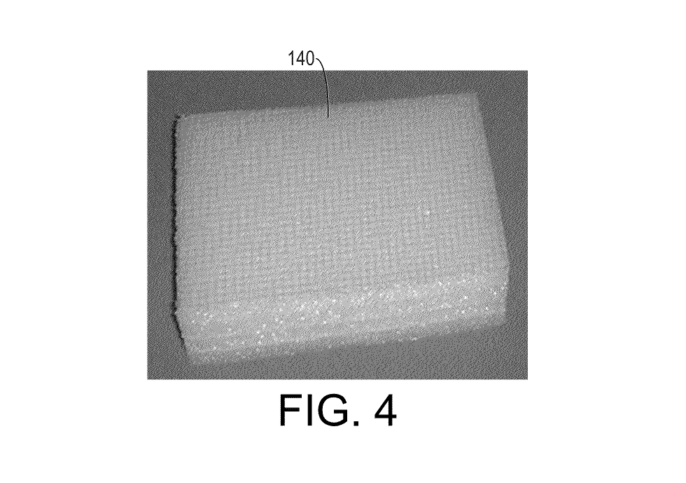

In this embodiment, the pre-stretched laminated oriented mesh fabric 114 and the first side 112 of the foam layer 110 are heated until a portion of the molecules of the pre-stretched laminated oriented mesh fabric 114 intermingles with a portion of the molecules of the first side 112 of the foam layer 110. Once fused, the resulting reinforced material 100 is cooled so that the pre-stretched laminated oriented mesh fabric 114 and the first side 112 of the foam layer 110 are securely bonded to each other. A photograph of a piece of reinforced material 140 made in accordance with this method is shown in FIG. 4.

Other methods of producing a mesh fabric fused to a foam layer may be employed without departing from the scope of the invention. For example, the mesh fabric could be fused to the foam layer by applying an adhesive that will bond the two together. Also, the mesh fabric can be applied to a surface and then a foam precursor can be extruded onto the surface and then cured so that the foam integrates itself into the mesh fabric. Similarly, the mesh fabric can be applied to the outer surface of a mold, a foam precursor can be injected into the mold and then allowed to cure.

The reinforced material 100 has many applications, including use in personal padding in which it is desired to use thinner padding or otherwise reduce bulk. One example of such an application is for use as padding in body armor. Other representative examples include use in athletic padding, use in packaging and use in automotive applications.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

1. A reinforced material, comprising:
(a) a foam layer having a first side; and
(b) a pre-stretched laminated oriented mesh fabric fused to at least a portion of the first side the pre-stretched laminated oriented polyethylene mesh fabric including a first layer of pre-stretched plastic split web including fibers disposed along a first direction and a second direction transverse to the first direction, different from the first direction, that is laminated to a second layer of pre-stretched plastic split web including fibers disposed along a third direction, that is different from the first direction and the second direction, and a fourth direction that is different from the first direction, the second direction and the third direction.

2. The reinforced material of claim 1, wherein the foam layer comprises a thermoplastic resin.

3. The reinforced material of claim 2, wherein the thermoplastic resin comprises polyethylene.

4. The reinforced material of claim 1, wherein the pre-stretched laminated oriented mesh fabric comprises a thermoplastic resin.

5. The reinforced material of claim 4, wherein the thermoplastic resin comprises polyethylene.

6. The reinforced material of claim 1, wherein the foam layer defines a lengthwise cut dividing the foam layer into two parts so that the pre-stretched laminated oriented mesh fabric acts as a hinge between the two parts.

7. The reinforced material of claim 6, wherein the lengthwise cut is at an angle other than 90° to the first side.

8. The reinforced material of claim 6, folded into a three-dimensional shape.

9. A reinforced foam, comprising:
(a) a polyethylene foam layer having a first side; and
(b) a pre-stretched laminated oriented polyethylene mesh fabric fused to the first side, the pre-stretched laminated oriented polyethylene mesh fabric including a first layer of pre-stretched plastic split web including fibers disposed along a first direction and a second direction transverse to the first direction, different from the first direction, that is laminated to a second layer of pre-stretched plastic split web including fibers disposed along a third direction, that is different from the first direction and the second direction, and a fourth direction that is different from the first direction, the second direction and the third direction.

10. The reinforced foam of claim 9, wherein the foam layer defines a lengthwise cut dividing the foam layer into two parts so that the pre-stretched laminated oriented mesh fabric acts as a hinge between the two parts.

11. The reinforced foam of claim 10, wherein the lengthwise cut is at an angle other than 90° to the first side.

12. The reinforced foam of claim 10, folded into a shape of a cooler.

13-20. (canceled)
